(19) United States
(12) Patent Application Publication
(10) Pub. No.: US 2016/0119365 A1
(43) Pub. Date: Apr. 28, 2016

(54) SYSTEM AND METHOD FOR A CYBER INTELLIGENCE HUB

(71) Applicant: Nissim Barel, Kfar Saba (IL)

(72) Inventor: Nissim Barel, Kfar Saba (IL)

(73) Assignee: COMSEC CONSULTING LTD., Petach Tikva (IL)

(21) Appl. No.: 14/526,214

(22) Filed: Oct. 28, 2014

(51) Int. Cl. H04L 29/06; G06F 17/30

(52) U.S. Cl. CPC H04L 63/1408; H04L 63/1416; H04L 63/0245; G06F 17/30705; G06F 17/30914; H04L 2463/121

(57) ABSTRACT

A method for defining and forming a cyber intelligence channel communicating with consumers is facing cyber threats in real time. The method includes collecting information, such that web crawlers and scrapers. The method also includes filtering the collected information, by filtering mechanisms founded on advanced algorithms. The method goes on to categorize the information into groups based on their unique characteristics, collecting capabilities and input and output constraints. The method further includes mapping the information and putting it into context and targeting and pinpointing the information, such that the data collected in the data intelligence collection unit is gathered through innovative technologies that enable automated and massive, yet targeted collection of the data that exists in the cyber space.

### FIELD OF THE INVENTION

The present invention generally relates to cyber security, and more particularly to a system and method to provide pre-emptive information by means of a cyber intelligence hub (CIH) that will enable organizations to deal with future risks in a proactive manner, prior to their materialization.

### BACKGROUND OF THE INVENTION

Social networking and the World Wide Web have transformed the way people connect and communicate with one another. In light of this evolving reality, a new landscape has been created, in which businesses and individuals are constantly available in the cyber space. As a result of these trends, more and more organizations are becoming active in the cyber space, in order to be available for any need that may arise. However, this increased cyber activity also leaves clear virtual footprints.

As the dependency of organizations and individuals on the cyber dimension increases, so does the appeal for attackers to target these parties and leverage their exposure for their needs. As this new reality is formed, traditional solutions for passively protecting the assets of organizations and individuals have become irrelevant or insufficient. Whether the organizational boundaries are logical or physical, by the time the threats are detected on the organizational level and the required defense mechanisms have been engaged, it is often too late.

### SUMMARY OF THE INVENTION

Accordingly, it is a principal object of the present invention to provide integrated multiple, cutting edge technologies with advanced analytical capabilities.

It is a further principal object of the present invention to provide pre-emptive information that will enable organizations to deal with future risks in a proactive manner, prior to their materialization.

It is another principal object of the present invention to provide a solution integrated into a single comprehensive hub which is capable of providing end to end cyber intelligence services to multiple users simultaneously.

It is one other principal object of the present invention to provide the formation of intelligence processing channels, from the initial design of the consumer's Essential Elements of Information (EEI's), through methods of operation, collection and analysis of the processing definitions.

It is one further principal object of the present invention to provide output of the Cyber Intelligence Hub (CIH) that enables users to detect cyber related threats prior to their occurrence and to take the necessary precautions by proactively tackling the source of the threats rather than responding to them.

The characteristics of the new cyber dimension are:
1. Globalization and flattening of the world
2. Advanced Persistent Threats (APT attacks)
3. Sophisticated technological challenges while facing the unknown
4. The asymmetry principle and highly skilled professionals
5. Constant connectivity and virtual world strengthening

A method is disclosed for defining and forming a cyber intelligence channel communicating with consumers is facing cyber threats in real time. The method includes collecting information, such that web crawlers and scrapers. The method also includes filtering the collected information, by filtering mechanisms founded on advanced algorithms. The method goes on to categorize the information into groups based on their unique characteristics, collecting capabilities and input and output constraints. The method further includes mapping the information and putting it into context and targeting and pinpointing the information, such that the data collected in the data intelligence collection unit is gathered through innovative technologies that enable automated and massive, yet targeted collection of the data that exists in the cyber space.

There has thus been outlined, rather broadly, the more important features of the invention in order that the detailed description thereof that follows hereinafter may be better understood. Additional details and advantages of the invention will be set forth in the detailed description, and in part will be appreciated from the description, or may be learned by practice of the invention.

### BRIEF DESCRIPTION OF THE DRAWINGS

In order to understand the invention and to see how it may be carried out in practice, a preferred embodiment will now be described, by way of a non-limiting example only, with reference to the accompanying drawings, in the drawings:

FIG. 1 is a schematic illustration of the high level information collection process and business logic, constructed according to the principles of the present invention;

FIG. 2 is a flow chart of the phase I definition and formation of the cyber intelligence channel, constructed according to the principles of the present invention;

FIG. 3 is a schematic illustration of the dashboard console for changes in notable events according to security domain, constructed according to the principles of the present invention; and

FIG. 4 is a schematic illustration of the dashboard console for changes in notable events according to urgency and time, constructed according to the principles of the present invention.

All the above and other characteristics and advantages of the invention will be further understood through the following illustrative and non-limitative description of preferred embodiments thereof.

### DETAILED DESCRIPTION OF PREFERRED EMBODIMENTS

The present embodiments relate to network application security, more particularly, but not exclusively, to an intrusion prevention system, device and method, which can operate efficiently on mobile devices and platforms.

1. The service rational is to enable the provisioning of Intelligence guided business continuity assurance, providing preemptive intelligence and adaptive learning capabilities. Real time intelligence generation concerning potential threats and provisioning of tools for proper handling of these threats with the aim of preventing, detecting and foreseeing future events. All of this with the goal of providing a decision supporting tool for the organization's management in regards to strategic decision making, while protecting the assets of the organization and minimizing the resulting damage.

Although the system could be used for a variety of appliances, the Cyber Intelligence Hub is preconfigured for the delivery of valuable information in three main domains:
1.1 Data Leakage Monitoring & Cyber Security “Early Warnings”—The most basic requirement of an intelligence system is to provide it users with relevant and valuable information, which enables users to evaluate the intention of its target and take the required measures for generating a the required outcome.
As such, one of the central services provided by the Cyber Intelligence Hub is the “Early Warning” service which provides organizations with valuable information (both in real time and following offline analysis), regarding potential cyber-attacks as well as leakage of sensitive information to the cyber space.
The goal of this service is to enable the users of the information to constantly update their evaluation of the threat map they are exposed to at any given moment and to initiate the necessary precautionary measures.
Although each organization may define its sensitive information items differently, the default configuration of the system is to search for data types as mentioned below. As such formats often contain unique characteristics, the systems of Cyber Intelligence Hub are capable of detecting the finger print of various data types prior to the customization process.
The collection and analysis capabilities focus on areas such as:
   Search of Confidential corporate financial data
   Sensitive company records: Documents, batches of emails, sensitive and proprietary source code, credit card numbers
   Corporate intellectual property (IP)
   Confidential employee data
   Confidential customer data
   False advertising: Announcements that can affect company stock value and overall business
1.2 Open Source Intelligence (OSINT), Security and Cyber Threat Related Feeds The CIH provides organizations with a pre-emptive, proactive and effective apparatus to respond to cyber threats. This CIH service utilizes OSINT (open source intelligence) and reputation information from various public sources and correlates it with customers' local security information and event management (SIEM) software, intrusion detection and prevention systems IDS/IPS, firmware's (FW's) internal events and indications in order to target cyber threats.
The systems correlation mechanisms are founded both on technical and textual sources which concentrate valuable data concerning cyber incidents, threats and alerts. Using specially developed application programming interfaces (API's), the information from these sources is gathered by the Cyber Intelligence Hub and formatted into a uniform template which is then fed into the advanced analysis engines of the hub for further analysis and information correlation.
By building such intelligence capabilities for organizations, the Cyber Intelligence Hub improves the responsiveness of organizations to cyber threats and enables them to pinpoint and be alerted to suspicious activities in real time (regardless of their origin).
1.3 Social Network Footprint & Trend and Sentiment Analysis—By correlating the cross channels, with the advanced analysis capabilities of the systems (which combine business and technological understanding of the cyber dimension); the Cyber Intelligence Hub is capable of displaying, in real time and at any given moment, the image of organizations as they are perceived over the cyber dimension.
This organizational portrait is created by utilizing wide scale internet crawlers and scrapers which gather all the vital information concerning the target organization based on a predefined rule set. The outcome of this enhanced collecting activity is an accumulation of a massive amount of data which is then correlated by proprietary algorithms which are incorporated within cutting edge modules for sentiment and lexicon analysis for determining the atmosphere in which the relevant organization was referred to, patters detection modules for extracting trends information from Big Data, entities connection interest maps for identifying targeted groups and more.
The deliverables of the Cyber Intelligence Hub enable organizations to achieve “intelligence driven” awareness, while understanding the organization's presence in the social media landscape.

### 2. Cyber Intelligence Hub—High Level Design

In order to cope with the technological and professional challenges that the new cyber reality presents, the Cyber Intelligence Hub (CIH) is founded on a hybrid platform which integrates innovative technologies with an advanced analysis center that enables real time customization of the gathering, analysis and management for each client's needs.
The Cyber Intelligence Hub operates through three main interfaces which guarantee the optimal interaction both between the CIH and its clients as well as the clients amongst themselves.
The Cyber Intelligence Hub is divided into the following units:
2.1 Technological and Textual Intelligence Gathering Unit—The intelligence gathering unit is founded on multiple advanced technologies which are divided into various information gathering groups. Each of the technologies groups is configured for collecting both raw and processed information from relevant sources.
Prior to the activation of the collection tools, each sensor is paired with a dedicated intelligence source based on the unique capabilities of that sensor. This process is set in order to support the data analysis processes which are being carried out in a dedicated unit, and are based on the origin of the collection source and information category (i.e. internal information, external information, hidden source).
The technology groups of the various intelligence collection sensors are divided as follows (detailed description is presented in the Method of Operations section):
   2.11 Web Crawlers and Web Scrapers for textual information
   2.12 Geo-Location Tools
   2.13 Public API's to relevant social networks such as Facebook, Twitter, LinkedIn, etc.
   2.14 Custom API's to Cyber Information Databases
   2.15 Public Logs and Security Databases
   2.16 Distributed Sensors for intelligence and log gathering (assimilated in organizations across the globe)
   2.17 Deepweb/Darknet forums—Gathered manually by a dedicated team from various sources such as Tors.
   2.18 New Technologies—collecting information through new, untested technologies.

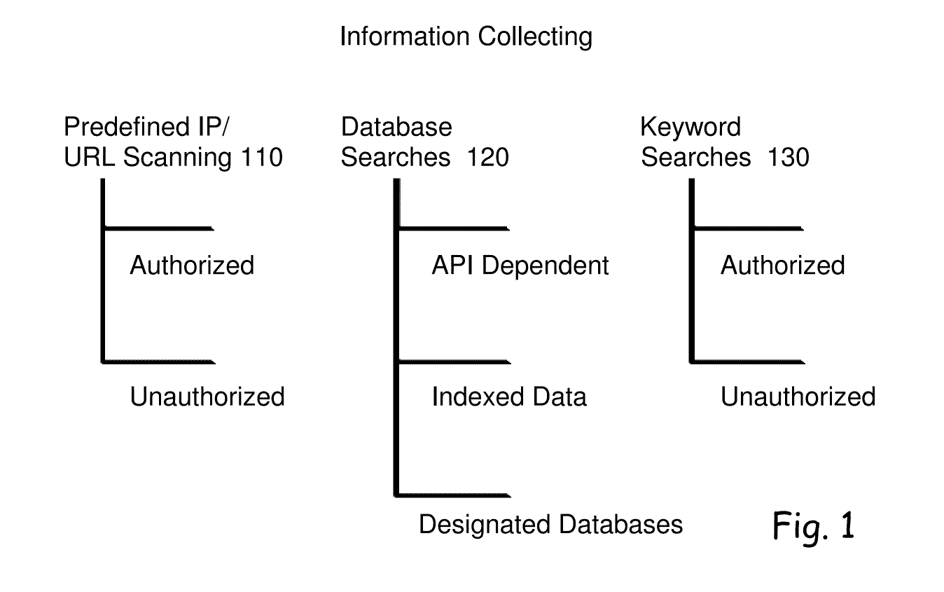

FIG. 1 is a schematic illustration of the high level information collection process and business logic, constructed according to the principles of the present invention. The information collection process involves the three aspects of information collecting: predefined Internet protocol (IP)/uniform resource locator (URL) 110, both authorized and unauthorized; database searches, both for application programming interface (API) dependent, indexed data and designated databases 120; and keyword searches 130, both authorized and unauthorized.
The information collected within the framework of all the teams is founded on a variety of sources that are chosen by the management team of the Cyber Intelligence Hub and are constantly being evaluated in order to improve the Information Collection processes. These include:
   CERT's (certifications)
   Various Information Security databases such a Malware lists, Blocked IP addresses, etc.
   Information Sharing and Analysis Center (ISAC's)
   Cyber Forums and Hackers Communities
   SANS
   Net-security.org
   Securelist.com
   Snippets
   DeepEnd Research
   arstechnica.com
   Social Networks
   reddit
   Delicious
   Flickr
   YouTube
   Flix
   Government Sources, Security agencies, Law enforcements and so on.
   European Network and Information Security Agency (ENISA)
   Regulation Organizations
   Academic Entities Sites
   Leading Industry Researchers
   Leading Information Security Industry Sites
   Vendors Websites
   Various RSS feeds
      A comprehensive bespoke list is created for each consumer based on their EEI's, and is updated constantly by the Cyber Intelligence Hub management team and the consumer's account manager.
2.2 Advance Analysis Unit—The advanced analysis unit is comprised of three central teams. The analysis activities carried out within the unit are based on sophisticated information correlation modules which correlate (both in real time and during offline analysis) information received from multiple sources such as data collectors and sensors, the vulnerabilities engine, content experts and more.
   The analysis processes carried out in the Advanced Analysis Unit are based on a holistic approach, which considers the relevant cyber threats and intelligence fragments, whether these are internal or external, consumer targeted or general threats, industry related or cross market warnings.
   The teams of the Advance Analysis Unit are as follows:
   2.21 Internal Threats Analysis Team—This team's work is founded on unique technological capabilities (correlation engines, advanced queries, internally developed scripts and more) which enable them to conduct innovative research and analysis of multiple databases 120 which store information fragments gathered from sensors located in the internal networks of various consumers and are aimed at gathering information from internal systems, from Firewalls and IPS's to organizational systems.
   2.22 External Threat Analysis Team—This team focuses on the analysis of the information which exists in the cyber space. Following preliminary filtering by the preset queries and rule sets, the massive amounts of information gathered through multiple sensors and collectors (detailed in the Method of Operations section) are analyzed by advanced modules which have the capability of correlating between different intelligence items, which are received from different sources and times.
   In order to enable overall customization of the intelligence sources which are entered into the system for factoring, the analysis system's interface includes an online feed changing mechanism. This mechanism supports multiple formats and enables systems to receive information from all sources, while translating them into a unified form for easier analysis, search and correlation of information.
   2.23 Hidden Sources Analysis Team—Information collected from these sources originates from multiple formats, that are often sanitized of content-less information (CLI), which enables further retrieval of data. The analysis and processing of the data is predominantly based on the proprietary risks and vulnerabilities engine, together with content specialists having expertise in cyber security, darknets and the deepweb worlds.
2.3 Intelligence Management, Reporting & Distribution Unit—The overall management of the Cyber Intelligence Hub will be performed from the Management, Reporting and Distribution unit.
   As the management unit controls the entire operation of the Cyber Intelligence Hub, in addition to its roles as manager and intelligence distributor, it is also responsible for the entire intelligence creation process, which includes the following:
   2.31 Concentration of Consumers Prerequisites and EEI's—Centralized database of each consumer's requirements is made prior to the feeding into the intelligence collection, reporting and distributing systems.
   The unique queries, which are predefined by the relevant collection and analysis teams are based on the input and demands gathered and processed by the team.
   2.32 Overall Correlation and Sources Evaluation—All information fragments, meticulously gathered from multiple sources, are stored in a dedicated database which is able to support complicated queries run by the team on a regular basis.
   Based on these queries, complex decision tree algorithms and unique correlation and pattern detection methods are all processed and fed into the management team's interface. This enables the team to obtain a real time status of each consumer and consequently, optimize the decision making process.
   2.33 Reporting and Distribution—Following automated and manual processes which correlate between the gathered information and each consumer's EEI's, the relevant information is fed directly into the consumer systems through specially developed API's.
   The goal of these API's is to enable unified formatting of the intelligence elements in a manner that will enable the consumers to view the obtained insights in their own systems such as SIEM's, SOC's and others.
   The urgency of the report and the service legal agreement (SLA) will be defined between the Cyber Intelligence Hub managers and the consumers in the first phase of operation. Reports which fall into the highest category of urgency/relevancy/importance, will be reported to the consumer directly via a phone call (and if not answered, in a short written report) which will be followed by the regular, elaborated analysis report.
   The distribution of the data to various consumers can be performed both in its raw form (unprocessed by the Cyber Intelligence Hub) or as a processed intelligence report which includes the insights generated from the Cyber Intelligence Systems and an up to date threat map, mitigation recommendations and more.

High Level Diagram of the Cyber Intelligence Hub Structure

### 3. Operations Method

The Operations Method of the Cyber Intelligence Hub is comprised of two phases which are carried out in parallel whilst constantly interacting with each other for continuous optimization of the process running in the center.
Phase I—Definition and Formation of the Cyber Intelligence Channel
Phase II—Continuous Development of Information Collection Sources and Advanced Data Analytics Capabilities
   As mentioned above, the initial phase of defining the Cyber Intelligence Channel provides as the “kick off” of the process with the client. Following this initiation of the engagement, both phases begin to run in a parallel cycle, which enables the learning mechanisms of the various CIH centers to generate insights from each event and automate the feeding and updating process in later cycles.
3.1 Phase I—Definition and Formation of the Cyber Intelligence Channel
This phase is mainly carried out within the Management, Reporting and Distributing Unit, which is in charge of overseeing the activities carried out within the Cyber Intelligence Hub at any time and is responsible for integrating the various alerts and data fragments received from the collecting team into a qualitative, relevant, real time intelligence for the consumers of the center's reports.
   The processes which are automatically initiated with the introduction of new members to the Cyber Intelligence Hub are as follows:
   3.11 Detailed Specification of the Essential Elements of Information (EEI's):
      3.111 Initial characterization of the types of cyber intelligence relevant for the consumer, desired deliverables, SLA's, etc. The gathered information is entered into the consumer's logs as the basis for the second phase. Once relevant information is received, whether by the information collection sensors or from the consumer API's, automatic updates will apply and serve the system for future references.
      3.112 Classification and Prioritization of Data Consumers—based on the specifications obtained during the high level design, a detailed design of the intelligence channel for each consumer is formed. Once the relevant design documents are completed, the information is entered through a designated API to the management console of the center. This information is then categorized by the nature of the consumer according to relevant metadata and prioritized based on the SLA set by the consumer.
      Each form is divided into two sections: the first section includes the mandatory fields which contain basic information regarding each consumer and serve as a benchmark for the overall collection and analytics. The second section includes consumer targeted information which varies from one consumer to another. This information is added automatically from the registration form to the consumer management console which is controlled from the management center.
      The mandatory fields included in each form include the following (amongst others):
         Consumer Authorized Personnel—This field is comprised of sub-groups which results are then used in order to generate an organization hierarchy tree.
         Based on this tree, the flow of information is then automatically configured between the systems of the Cyber Intelligence Hub and the various interfaces of each consumer.
         Intelligence Oriented SLA—As different times call for different measures, the Cyber Intelligence Hub is designed to support real time changes of the EEI's through dedicated modules which segregate the real time information from the offline analysis which is correlated with historical data from various sources. This enables the dedicated team, which is formed for supporting ad hoc requirements from consumers (prior to big software releases, new campaigns and so on), to provide real time qualitative intelligence without interfering with the regular activities of the center or changing the EEI's of the consumer in the center's centralized database.
         Information Delivery Channels—The delivery channels for each source will be defined in the systems and relevant Secure APIs will be applied based on the central data classification mechanism. Every interface will be customized in light of the predefined SLA's, EEI's and specific requirements of each consumer.
         Essential Elements of Information Requests—The initial specifications for the clients EEI's are broken down into their components in order to define the format in which each client's systems will interact with the API's of the relevant CIH center (i.e. collection, analytics and management). As a default, the inventive forms (which are based on common forms that interact with the leading collection and analytics tools) are offered to each user.
         Information Rating and Prioritization—Based on the information defined in high level, the authorized members of the Management Center will create a detailed design of the EEI. Each element of the EEI receives a score of 1-5 based on a predefined matrix that is approved by the consumer. The score is factored based on the two elements of the matrix: 1. The level of compatibility to the original EEI as set by the consumer and 2. The source rating as it is evaluated at the time the information is obtained.
      3.113 Detailed Design and Formulation of the Intelligence Making Process—The method of operations of the Cyber Intelligence Hub is predefined in an exhaustive rule set which was developed by a dedicated team of cyber content and technological experts. Nevertheless, in order to ensure optimization of the process, both from the resources consumption and EEI's compatibility perspective; designated rules will be applied for each cyber intelligence consumer.
      3.114 Data Classification—In order to enable constant prioritization of each data element in real time, in accordance with the specific needs of each consumer; the Data Classification module retrieves information from multiple systems at every given moment. As the classification of each Data Element is dependent on many variables, the data classification mechanisms include several interfaces with the complimenting system within the center.
      This process, which is set to run in cycles and forms a real time data classification database, enables all three teams to receive critical information in regards to the characteristics of the various data elements. These include analysis factors, such as:
         Data Credibility
         Source Credibility
         Data Element Essentiality
         Real Time Analysis of the Report Relevancy
         More.
      Naturally, many of the feeds which nurture the Data Classification module come from the collecting sources evaluation system which is critical for the evaluation of the data.
   3.12 Data Handling Processes Specifications—These specifications define in detail the boundaries and settings of the data flow process once the elements of information are created and the routes in which they are allowed to travel are defined.
   As a part of this process, the following settings are configured:
      3.121 Authorized entities for receiving intelligence
      3.122 Following the automated data collection, what processes and filters should apply for each consumer.
      3.123 To which systems is the information distributed and which API's are required for the optimization of the process.
      3.124 Intelligence Data Validation requirements are preset in the system in order to ensure optimal time consumption both from the analysis and consumer teams.
      3.125 For each information source and in regards to each consumer, information concerning intelligence correlation are configured and a threshold for reporting is being predefined in the relevant systems.
      This includes configuration of the system for correlating information with parallel data collection systems as well as existing data elements stored in the central intelligence database (both as raw data and processed information)
      3.126 Intelligence validation or refutation processes
   3.13 Intelligence Generation Processes Customization—The Cyber Intelligence Hub, including its sub units, operates based on a predefined rule set which translates the accumulated knowhow of the intelligence and technological experts into an operational flow chart which is comprised of decision trees, process critical junctions and more.
   Nevertheless, in order to customize the intelligence generation processes of the Cyber Intelligence Hub for each data consumer, the decision supporting engine is developed with an easy to use interface which enables the dedicated Point of Contact (POC) of the present invention to customize the general processes to the specific needs of each consumer.
   3.14 Ongoing Validation of Operations Processes—Following the customization of the process, definition of the information channels, authorized personnel and other elements which are critical to the operation of the Cyber Intelligence Hub, a supervisory monitoring process is established in order to gather information on the executed process regularly.
   The gathered logs are then stored into a central database in which it is stored both with previous logs gathered from a single consumer and with general logs gathered from complimenting systems that could have an impact on the data collection process.
   Based on advanced queries developed by a dedicated team which is comprised of members of all three Cyber Intelligence Hub centers, alerts are generated concerning the relevancy of the process, their compatibility with the requirements of each consumer, etc. These are then set as basis for the optimization process for each consumer and the updates are fed into the system for evaluation for a predefined duration.
   3.15 Lexicon and Sentiment Specifications—In order to enable the Cyber Intelligence Hub to interact with its consumer's internal systems in a manner that will be transparent to them, an initial alignment of the joint dictionary should be made.
   This process sets the foundations for the customization of the consumer system's APIs, Intelligence Evaluation Criteria, etc. During this process, basic settings will be defined.
   These include:
      3.151 Data Element Relevancy/Irrelevancy (both in time and context aspects)
      3.152 Deceiving Data Elements
      3.153 Cyber Warfare
      3.154 SLA
      3.155 Urgency
      3.156 Rating
         All Information Collection & Intelligence work is carried out in light of the Intelligence Generation Building Blocks described below. The desired goal if this process is to provide a solution/response/work plan to any threat that is detected by the system.
         Alternatively, a complimenting outcome of the Cyber Intelligence Hub deliverable, is providing the various consumer with intelligence reports which describe the way the organization appears in the cyber world, how it is perceived and the cyber/social footprint it leave behind. This, as well as all other deliverables that are generated regularly by the system, are then used by the various data consumers as measurement and evaluation tools for their activities.

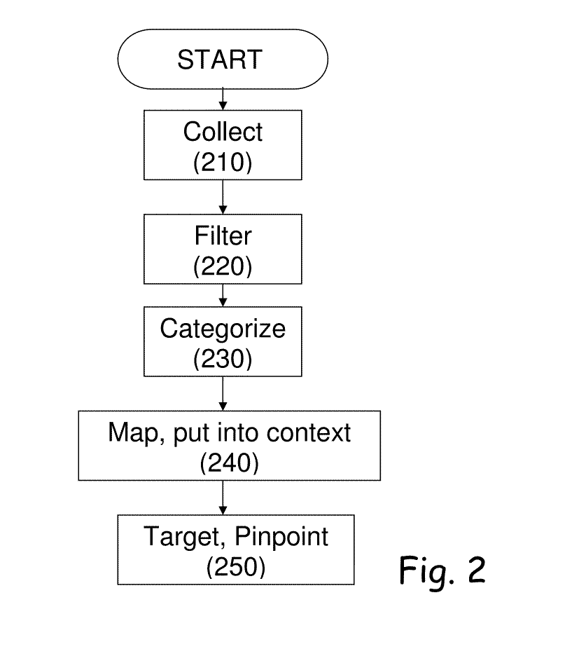

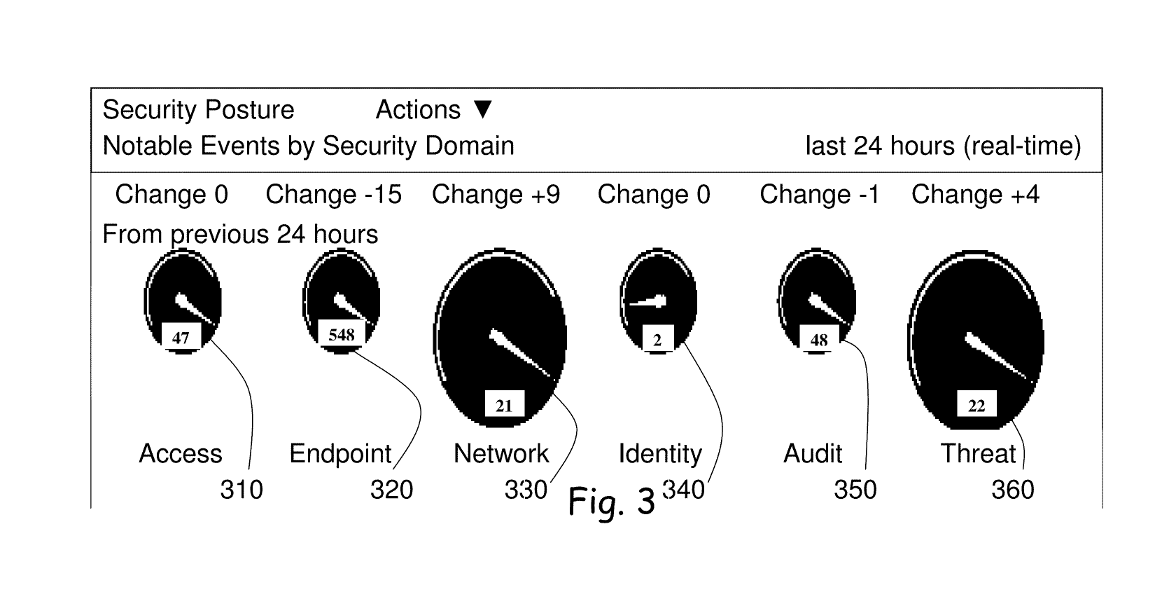

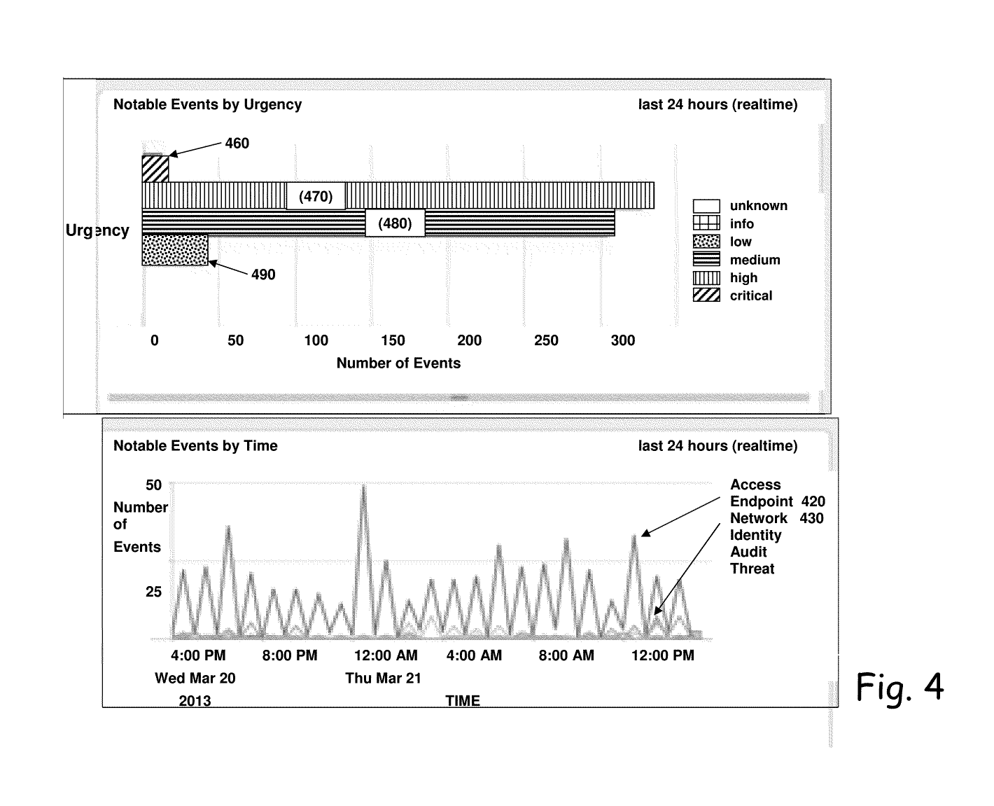

FIG. 2 is a flow chart of the phase I definition and formation of the cyber intelligence channel, constructed according to the principles of the present invention.
3.2 Phase II—Information Collection Sources & Data Analytics Capabilities Development
The intelligence collection 210, analysis and processing are carried out in the central units of the Cyber Intelligence Hub by multiple systems and technologies. Some process are run in an automated, timely manner by dedicated algorithms, and others are performed manually by specially trained analysis and content experts with multidisciplinary skills (amongst others, Cyber Intelligence, Information Security, Business Continuity, intelligence, technology, operational risk managers).
   3.21 The Cyber Intelligence Hub performs initial filtering mechanisms 220, that may be either automated or manual. These mechanisms are founded on advanced algorithms which consider all the relevant information at real time and enable handling this information in an educated manner.
   The unique filtering mechanisms 220 are implemented throughout the entire intelligence making process, from the analysis and collecting systems 210, through information processing and categorization 230, and up to the reporting and distribution of the information to the consumers.
   3.22 The technologies are categorized 230 into groups based on their unique characteristics, collecting capabilities 210, input and output constraints.
      3.221 Web Crawlers & Web Scrapers—The vast majority of the data collected in the data intelligence collection unit, is gathered through innovative technologies that enable automated and massive, yet targeted 250, collection of data 210 that exists in the cyber space.
      In order to maintain the confidentiality of the process and minimize any impact that the actual search and collection may cause, the Cyber Intelligence Hub uses next generation web crawlers and scrapers which can operate in the cyber space undetectably and gather a vast amount of information based on specific settings and configurations. These settings are preset into the systems as well as updated in real time for the optimization of the data collection processes.
      The proprietary architecture of the web crawlers and scrapers which characterizes the operation of the information collection unit 210, was designed to ensure that the collection processes are optimized to detect the type of gathered data, its relevancy and origin.
      The bespoke architecture is comprised of sub-architectures, each developed for the handling of different intelligence sources. These include the collection of data both from technological sources (which provide technical information in various formats) and textual sources (i.e. Facebook, Twitter, LinkedIn, Relevant Forums and more).
      In addition to the proprietary Web Crawlers and, the systems also integrates off-the-shelve solutions which are customized and configured by the experts of the Cyber Intelligence Hub to create wider information collection capabilities.
      3.222 Automated Analysis for Indexed Data—One of the greater added values of the interaction between the Cyber Intelligence Hub and the present invention is a knowledge base.
      This database includes various data elements, gathered throughout the years from multiple sources in a variety of formats. In order to standardize the content of the database and enable efficient processing of the stored information, customized scripts and algorithms were created by the Cyber Intelligence Hub experts, in order to “translate” the raw data into a uniform format and enable the various teams to run advanced queries with the aim of detecting patterns, correlating the existing information to new data, extract relevant insights from the stored element and more.
      3.223 Big Data Analytics—In order to maximize the extraction of valuable intelligence from the vast quantities of collected and stored data, the Cyber Intelligence Hub utilizes cutting edge analytics engine, which enables advanced analysis of the data based on correlation between information received from multiple sources by restructuring it into a unified format.
      The Big Data Analytics engine is fed by a number of API's which originate both from internal sensors, located in the organizational networks of the Cyber Intelligence Hub consumers, and multiple external sources which collect various types of information (i.e. geo-locations, IP addresses lists, known vulnerabilities, twitter messages and more) as predefined in accordance with the consumers EEI's.
      The Big Data Engine then enables the advanced analysis team to develop insight from the gathered data by running internally developed algorithms, which are aimed at detecting patterns in what often seems like unrelated fragments of information.
      3.224 Geo-Analytics Analysis Tools—The relevancy of information to a consumer depends on several factors such as the match between the consumer's EEI's and the information, the duration in which the informational fragment remains relevant for the consumer and more.
      As the information gathered by the Cyber Intelligence Hub collectors is categorized into different types of information; different analytical capabilities are required in order to analyze data elements which stem from various sources. One of these data type groups if often referred to as “Content-less Intelligence” (CLI). Despite of the weak nature of such information, in many cases, proper analysis of each element's characteristics results in valuable insight.
      The geo-location extracted from various sources (i.e. tweets, digital photos, IP addresses and more) is crucial for the formation of an exhaustive status report which refers to all the cyber elements of each consumer at every given moment.
      3.225 Relations Modeling Tools—One of the correlation methods which is used in the Cyber Intelligence Hub for determining the connection between fragments of information that may seem unrelated, is the connection modeling engine.
      This engine is capable of receiving raw data from multiple information sources and to perform additional analysis on it in order to detect interactions between different entities, behavior characteristics, background etc.
      The outcome of the relations analysis is presented in an accessible manner, through an intuitive, innovative GUI, which enables the advanced analysis team members to extract new insights from the collected information while changing the search algorithms for complete extraction of potential data from the information.
      The visual presentation of the connection map 240, assists the Cyber Intelligence Hub teams in determining the threats each consumer is facing in real time, regardless of the origin of the information, its time stamp or source.
3.3 Cyber Intelligence Hub Feeds—Collecting and Analysis Capabilities
   3.31 Open Source and Social Media Crawlers and Scrapers—As more and more people connected to the internet, the amount of available raw data grew exponentially.
      Moreover, as the connectivity of people increased, so new platforms and technologies emerged which enable them to communicate with each other, manage an active online social life and even create identities. This trend was only emphasized by the extended connectivity that was introduced to the world through mobile channels and advanced communication services.
      This connectivity revolution has made the data scattered in the internet especially via social networks into significant sources of information.
      The endless amount of data which contains valuable information concerning people, organizations and trends, is often disregarded due to our highly limited capabilities for handling such amounts of data. In order to deal with this information overload, the Cyber Intelligence Hub utilizes multiple tools which are based on powerful collecting engines and sophisticated, big data analysis algorithms and technologies which provide the operating teams within the center to extract valuable and focused insight concerning the subject of the analysis.
      By transforming and perfecting techniques that were created in order to optimize search results into advanced capabilities for data collection and analytics, the Cyber Intelligence Hub is capable of gathering information continuously from predefined sources in a non-detectable manner. This information can then be correlated in order to create user profiling and arrive at conclusions regarding intents, threats or trends which are of interest to the consumers.
      In order to ensure that the Cyber Intelligence Hub provides comprehensive intelligence, the system supports an array of platforms such as social media, news articles, blogs, RSS feeds, video sites forums, user generated content, etc.
      The collected information is then analyzed by a set of analytics engines, each with different capabilities which complement each other and result in an exhaustive view of a certain topic. Two key capabilities which are included in these analytical engines are:
         Sentiment Analysis—This engine determining the intent of users when dealing with immense amounts of data is the sentiment analysis engine.
         This engine enables the Cyber Intelligence Hub to develop insights regarding the attitudes and opinions of users regarding a specific topic by reviewing the input they provided, detecting key words in their posts and attributing these words to a positive or negative context.
         Feed Settings Example
         Following the configuration of the sentiment analysis engine, the gathered information is reviewed and words which can implicate specific opinions or intents by users are detected.
         The result is a report which visually demonstrates the cyber buzz around a specific topic.
         Sentiment Analysis Report Example
         Contact Modeling Engines—Once the vast amounts of data which are accessible over the internet are gathered, the highly complex challenge of connecting the dots into a coherent picture remains.
         The ability of the Cyber Intelligence Hub to connect these dots during the information analysis phase is a key stage in the process of detecting patterns, pointing out unusual activity and alerting consumers of the intent of any entity to perform an attack against them.
         In addition to the data correlation mechanisms which have the capability of attributing different pieces of information into a single report based on various characteristics such as key words, geo-location, content-less information and so on, a dedicate engine for modeling the relationships between various subjects of interest is applied.
         The engine is fed by various sources and by cleaning the different formats of each social feed, the engine can unify various entities which belong to the same person or organization into a single profile. The result can then be presented in a visual manner which demonstrates the connection flow map between the various entities which are related to a specific topic, trend, website or any other form of EEI.
         FIG. 3 is a schematic illustration of the dashboard console for changes in notable events, constructed according to the principles of the present invention. Patterns of change are detected for exemplary notable events in the various security domains, such as: Access 310, Endpoint 320, Network 330, Identity 340, Audit 350 and Threat 360.
         FIG. 4 is a schematic illustration of the dashboard console for changes in notable events according to urgency and time, constructed according to the principles of the present invention. Urgency counts for critical 460, high 470, medium 480 and low 490 are shown in a comparative bar graph. There are no instances of unknown and informational recorded. Times and number of events are shown for access, endpoint 420, network 430, identity, audit and threats are graphed, but only endpoint 420 and network 430 appear in large enough numbers to be visible in this example.
   3.32 Botnets—In the emerging cyber era, the use of botnets have become commonplace. Among the technologies of the Cyber Intelligence Hub, dedicated technologies for information gathering and analysis of botnets and botnets related data are used.
   In order to gather such information, the various technologies incorporated into the Cyber Intelligence Hub apply diverse intelligence methods in order to generate a real time intelligence and threat map.
   The unique combination of technologies and skills ensures that the gathered information provides accurate, real time coverage of the operating botnets and malware which could use the Cyber Intelligence Hub for the generation of an accurate threat map. The Cyber Intelligence Hub generates this map in a modular, scalable and generic manner in order to enable the analyzing team, and consequently the consumers to analyze the information according to different parameters such as geography, business sector, threat, etc.
      The methods which are used by the Cyber Intelligence Hub for obtaining the information required for creating the intelligence reports are founded on a combination of methods including the operation of dedicated honeypots, monitoring sensors which are customized specifically for gathering botnet information, spam detection systems, web crawlers and scrapers and more.
   3.33 Geo-Location Tools—The use of Location Based Services (LBS) for business, security and intelligence purposes has been going on for many years. Whether the geo-location data was based on contactless information such as IP routing info, zip codes or any other form of information, the existence of such data opened new opportunities for entities who wanted to obtain complementing information concerning a dedicated subject of interest or regarding wider trends of mass crowds.
   Nevertheless, the exponential rise in the use of mobile phones in general, and specifically smartphones, seems to have changed the intelligence landscape dramatically. As the caller ID changed the perception of anonymity for the callers, the use of mobile phones inserted another enigma into the equation. Nowadays, the question is no longer who you are but also where you are. This, together with the ability of users to hide their identity in the cyber dimension and carry out attacks from their home created a new challenge for individuals, organizations and nations.
   As people are performing more and more of their cyber-world activities through their mobile phones, their location during these activities is becoming more obscure. Naturally, these new capabilities are opening a new range of appliances such as maintaining constant contact with friends, receiving localized services wherever you are and more. Nevertheless, these new opportunities contain a new set of cyber threats. These include the ability of people to trace one another, perform dedicated attacks and more.
   The Cyber Intelligence Hub utilizes a TweetMap which monitors social media sentiment to display trends, detect localized cyber-attacks, predict election results and map the most exciting and interesting events worldwide. By applying machine learning algorithms, the Cyber Intelligence Hub is capable of pinning tweets to accurate locations even when there is no geo-location information in the Tweet itself.
      The TweetMap is updated automatically through harvested tweets, which are predefined into the TweetMap queries in a customized manner in accordance with each consumer's requests or EEIs submitted to the Management Unit of the Cyber Intelligence Hub. Moreover, the unique data correlation modules of the Cyber Intelligence Hub enables the operating team to increase the accuracy of the geo-location analysis by associating data elements gathered through additional Cyber Intelligence Hub sensors.
      These supporting sensors include information which is gathered from dedicated Geo-Location databases such as FourSquare, Facebook CheckIn and others, and is gathered through a dedicated APIs to these servers (when possible) or by applying web crawlers and scrapers which have the capability of gathering only the relevant information from these sites.
      The creation of a Geo-Location Interest Map is being done as follows:

Having described the present invention with regard to certain specific embodiments thereof, it is to be understood that the description is not meant as a limitation, since further modifications will now suggest themselves to those skilled in the art, and it is intended to cover such modifications as fall within the scope of the appended claims.

I claim:

1. A method for defining and forming a cyber intelligence channel/hub (CIH) communicating with consumers, wherein the CIH faces cyber threats in real time, the method comprising:
Collecting and delivering information, such that web crawlers and scrapers, which characterize the operation of an information collection unit, are designed to ensure that the collection processes are optimized to detect the type of gathered data, its relevancy and origin;
filtering the collected information, by filtering mechanisms founded on advanced algorithms, which consider all the relevant information at real time and enable handling this information in an educated manner;
categorizing the information into groups based on their unique characteristics, collecting capabilities and input and output constraints;
mapping the information and putting it into context, such that a visual presentation of a connection map assists in determining the threats each consumer faces in real time, regardless of the origin of the information, its time stamp or source; and targeting and pinpointing the information, such that the data collected in the data intelligence collection unit is gathered through innovative technologies that enable automated and massive, yet targeted collection of the data that exists in the cyber space,
such that the CIH enables users to detect cyber related threats prior to their occurrence and to by proactively tackle the source of the threats rather than only responding to them.

2. The method of claim 1, wherein the CIH IS integrated into a single comprehensive hub which is capable of providing end to end cyber intelligence services to multiple users simultaneously.

3. The method of claim 1, wherein filtering is by date.

4. The method of claim 1, wherein filtering is by type of data.

5. The method of claim 1, wherein filtering is by date and type of data.

6. The method of claim 1, further comprising correlating the collected information, based on mechanisms which have the capability of attributing different pieces of information into a single report based on various characteristics

7. The method of claim 6, wherein the characteristics comprise key words.

8. The method of claim 6, wherein the characteristics comprise geo-location.

9. The method of claim 6, wherein the characteristics comprise content-less information.

10. The method of claim 1, wherein the CIH is preconfigured for the collection and delivery of data leakage monitoring and cyber security “early warnings” information.

11. The method of claim 1, wherein the Early Warning” service provides organizations with information regarding potential cyber-attacks as well as leakage of sensitive information to the cyber space.

12. The method of claim 1, wherein the CIH is capable of detecting the finger print of various data types.

13. The method of claim 1, wherein the collection capabilities focus at least on:
search of confidential corporate financial data;
sensitive company records: documents, batches of emails, sensitive and proprietary source code, credit card numbers;
corporate intellectual property (IP);
confidential employee data;
confidential customer data; and
false advertising: announcements that can affect company stock value and overall business.

14. The method of claim 1, wherein the CIH is preconfigured for the collection and delivery of Open Source Intelligence (OSINT), Security and Cyber Threat Related Feeds.

15. The method of claim 144, wherein the information gathered by the CIH is formatted into a uniform template which is then fed into the advanced analysis engines of the hub for further analysis and information correlation.

16. The method of claim 1, wherein the CIH is preconfigured for the collection and delivery of Social Network Footprint and Trend and Sentiment Analysis by correlating the cross channels, with the advanced analysis capabilities of the systems, and wherein the CIH is capable of displaying, in real time and at any given moment, the cyber image of the organization.
